(19) United States
(12) Patent Application Publication
(10) Pub. No.: US 2003/0022632 A1
(43) Pub. Date: Jan. 30, 2003

(54) Mobile communications device utilizing a deployable and retractable ear piece

(76) Inventor: George Bernhart, Trophy Club, TX (US)

Correspondence Address: THOMAS B. HAYES, NOKIA INC., 6000 CONNECTION DRIVE, MD 1-4-755, IRVING, TX, 75039, US

(21) Appl. No.: 09/916,904

(22) Filed: Jul. 27, 2001

(51) Int. Cl. H04B 7/00

(52) U.S. Cl. 455/90; 455/66; 455/74; 455/575

(57) ABSTRACT

The invention comprises a mobile communications device having an attachable device that may be attached to, for example, a belt clip, and a mobile phone communicable coupled with the attachable device. The attachable device comprises a deployable and retractable ear piece and an output node containing a bias signal when the ear piece is deployed. The mobile phone comprises a bias signal port electrically coupled to the output node. The mobile phone activating a communications channel having an incoming transmission upon deployment of the ear piece and deactivating the communications channel upon retraction of the ear piece.

### FIELD OF THE INVENTION

The present invention relates to a mobile communications device utilizing a deployable and retractable ear piece and, more particularly, to a method and system for activating and deactivating a communications channel upon deployment and retraction of the ear piece.

### BACKGROUND

Service providers of mobile communications often seek out networking equipment that provides enhanced, quality service and mobile communications equipment that has an attractive look and feel, useful functional features, and reasonable cost in an attempt to sell as much service and mobile communications equipment as possible. Therefore, equipment manufactures are constantly seeking to enable quality services, improve aesthetic appeal, and functional features also in an attempt to sell as much product as possible. Functional features of a mobile phone often are attempts to facilitate use and, therefore, simplify operation. These functional features help make the phone attractive to potential customers. A common complaint of mobile phone use is that its use causes distraction, for example, while driving or even walking. Therefore, facilitated operation of a mobile phone is often considered a useful functional feature. Attachable devices, such as belt clips or mounting stations used in automobiles, are commonly used to secure a mobile phone to a person or object. Additional devices, such as deployable and retractable ear pieces, are often used in connection with attachable devices to facilitate hands free operation of a mobile phone. However, the user must still physically activate and deactivate the mobile phone to receive and terminate a call.

As may be seen, additional enhancements to functional features of a mobile device could prove a useful article of manufacture.

### SUMMARY

The present invention provides a method and system for activating and deactivating a communications channel upon deployment and retraction of an ear piece attached to a mobile communications device.

In an embodiment, the invention provides a mobile communications device comprising an attachable device that may be attached to, for example, a belt clip, a support member for coupling with the attachable device, and a mobile phone for coupling with the support member. The attachable device comprises a deployable and retractable ear piece, an engagement slot, and at least one output node comprising a bias signal when the ear piece is deployed. The support member comprises an engagement member for coupling with the engagement slot, at least one signal lead for electrically coupling to the at least one output node, and at least one latching mechanism. The mobile phone comprises at least one slot for receiving the at least one latching mechanism, and a bias signal port electrically coupled to the at least one signal lead. The mobile phone activating a communications channel upon deployment of the ear piece and deactivating the communications channel upon retraction of the ear piece.

### BRIEF DESCRIPTION OF THE DRAWINGS

For a more complete understanding of the present invention, including its features and advantages, reference is made to the detailed description of the invention, taken in conjunction with the accompanying drawings of which:

FIG. 1 is a cut away view of a attachable device having a deployable and retractable headset;

FIG. 2 is a support member for securing a mobile phone to the mountable device and conducting current over of a conductive path;

FIG. 3 is a mobile phone having a function for activating and deactivating a communications channel upon deployment and retraction of a deployable and retractable ear piece.

### DETAILED DESCRIPTION

While the use and implementation of particular embodiments of the present invention are presented in detail below, it will be understood that the present invention provides many inventive concepts, which can be embodied in a wide variety of contexts. The specific embodiments discussed herein are mere illustrations of specific ways for making and using the invention and are not intended to limit the scope of the invention.

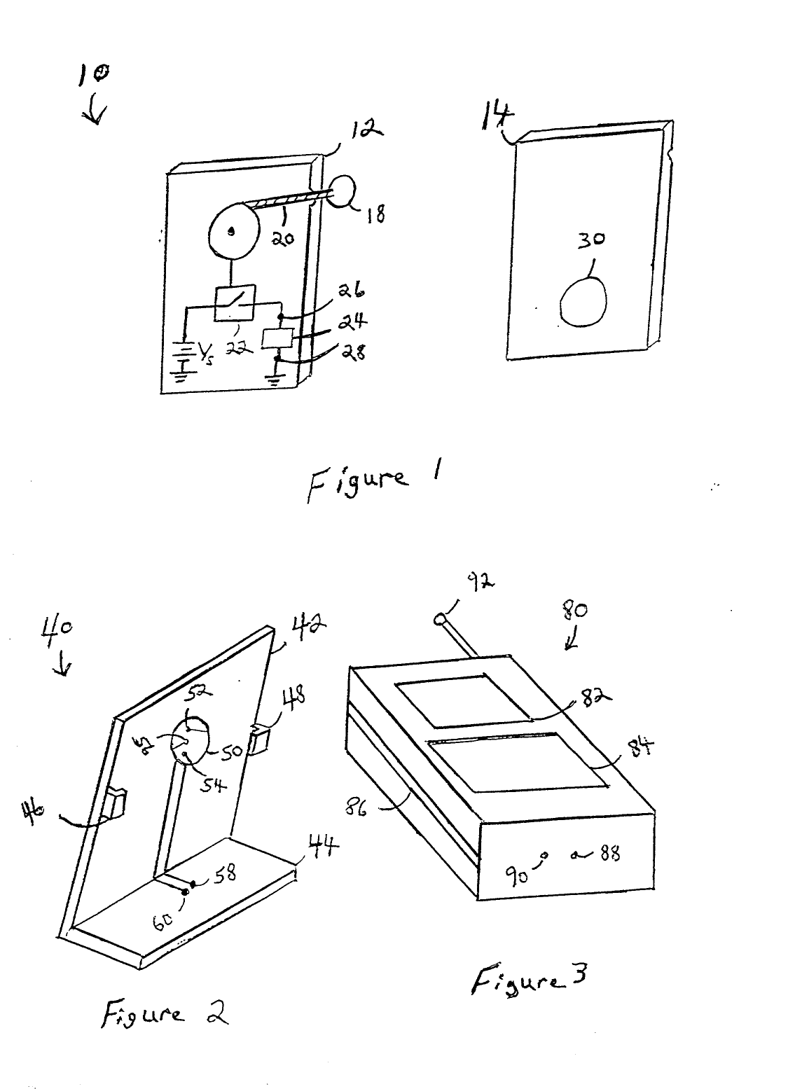

Referring now to FIG. 1 where a cut away view of an attachable device having a deployable and retractable headset is illustrated and denoted generally as 10. Attachable device 10 comprises a back cover 12 and a front cover 14 that when coupled together may be attached to, for example, a pocket of a pair paints, a belt, or the dash of an automobile. Back cover 12 comprises a friction wheel 16 for allowing deployment and retraction of an ear piece 18 attached to friction wheel 16 through a conductive wire 20. Motion of friction wheel 16 in the direction of deployment generates current causing the closure of switch 22, creating continuity between a voltage source Vₛ and an external circuit 24. External circuit 24 may be attached at a circuit node 26 coupled to voltage source Vₛ through switch 22 and a circuit node 28 coupled to ground. External circuit 24 may have a select amount of impedance for conducting a select amount of current. Upon retraction of ear piece 18 by friction wheel 16, current in opposite direction is created causing switch 22 to open, creating a discontinuity between voltage source Vₛ and external circuit 24. Front cover 14 provides protection of the internal components and comprises an engagement slot 30 for mating with an external device comprising external circuit 24. Engagement slot 30 exposes circuit nodes 26 and 28 allowing external circuit 24 to be coupled to circuit nodes 26 and 28.

Turning now to FIG. 2, where a support member for securing a mobile phone and conducting current over of a conductive path is illustrated and denoted generally as 40. Support member 40 comprises a back plane 42 and a base plane 44. Back plane 42 further comprises an engagement member 50 for coupling to engagement slot 30 and, therefore, coupling support member 40 to attachable device 10. Engagement member 50 further comprises member nodes 52, 54, and 56. When engagement member 50 is mated with engagement slot 30, circuit nodes 26 and 28 make conductive contact with engagement nodes 52 and 54 and engagement node 56 makes conductive contact with conductive wire 20. Back plane 42 further comprises latching mechanisms 46 and 48 for securing a mobile phone to back plane 42. Although FIG. 2 illustrates a support member 40 using latching mechanisms 46 and 48 to secure mobile phone, other securing means may be used, such as using a protruding member and engagement slot similar to the method used with respect to attachable device 10 and support member 40. Base plane comprises a bias node 58 and an audio node 60 having leads electrically coupled with member node 52 and 56.

Turning now to FIG. 3, where a mobile phone having a function for activating and deactivating a communications channel upon deployment and retraction of a deployable and retractable ear piece is illustrated and denoted generally as 80. Mobile phone 80 comprises a display 82 for displaying visual information, a keypad 84 for receiving user commands, a slot 86 for receiving latch 46, a bias port 88, a audio port 90, and an antenna 92 for sending and receiving RF signals. Although mobile phone is illustrated with only a bias and audio port, one skilled in the art of mobile communication systems will recognize mobile phone 80 may comprises ports in addition to just an audio and bias port. Mobile phone 80 when latched to support member 40 causes bias port 88 and audio port 90 to have conductive contact with bias node 58 and audio node 60 respectively. Upon receiving a bias signal from bias port 88, mobile phone 80 determines if an incoming transmission is present on a communications channel. If an incoming transmission is present, mobile phone activates the communication channel. Upon retraction of the ear piece, the bias signal will not be present at bias signal port and, therefore, the mobile phone will deactivate the communication channel.

While this invention has been described with reference to particular embodiments, this description is not intended to be limiting. Various modifications and combinations of the illustrative embodiments, as well as other embodiments of the invention, will be apparent to persons skilled in the art. It is, therefore, intended that the appended claims encompass any such modifications or embodiments.

What is claimed is:

1. A method of deploying and retracting an ear piece attached to a mobile phone, the method comprising the steps of:
producing a bias signal upon detection of the ear piece being deployed;
coupling the bias signal to a bias signal port of the mobile phone;
determining if an incoming call exist upon receiving the bias signal at the bias signal port;
activating a communications channel if an incoming call exists.

2. The method of deploying and retracting an ear piece attached to a mobile phone as recited in claim 1 further comprising the step of deactivating the communications channel upon retraction of the ear piece.

3. A method of deploying and retracting an ear piece attached to a mobile phone, the method comprising the steps of:
producing a bias signal upon detection of the ear piece being deployed;
coupling the bias signal to a bias signal port of the mobile phone;
receiving a transmission on a communication channel;
determining if a bias signal exist at the bias signal port;
activating a communications channel if the bias signal exists.

4. The method of deploying and retracting an ear piece attached to a mobile phone as recited in claim 1 further comprising the step of deactivating the communications channel upon retraction of the ear piece.

5. A mobile communications device comprising:
an attachable device having a deployable and retractable ear piece and at least one output node, the at least one output node comprising an output node containing a bias signal when the ear piece is deployed; and
a mobile phone having at least one signal port, the at least one signal port includes a bias signal port electrically coupled to the at least one output node, the mobile phone activating a communications channel upon receiving an incoming transmission and the bias signal.

6. The mobile communications device as recited in claim 5, wherein the attachable device further comprises an engagement slot.

7. The mobile communications device as recited in claim 6 further comprising:
a support member having an engagement member for coupling with the engagement slot;
at least one signal lead for electrically coupling to the at least one output node, the at least one signal lead comprises a signal lead electrically coupled the output node and the bias signal port; and
at least one latching mechanism.

8. The mobile communications device as recited in claim 7, wherein the mobile phone further comprises at least one slot for receiving the at least one latching mechanism.

9. The mobile communications device as recited in claim 5, wherein the mobile phone further comprises an audio port electrically coupled to the at least one signal lead.

10. The mobile communications device as recited in claim 5, wherein the attachable device further comprises:
a friction wheel for deploying and retracting the ear piece;
a voltage source; and
a switch electrically coupled to the friction wheel, the voltage source, and the output node, the switch having a closed state when the ear piece is deployed and an open state when the ear piece is retracted.

11. The mobile communications device as recited in claim 5 further comprises the mobile phone deactivating the communications channel upon retraction of the ear piece.
